(19) United States
(12) Patent Application Publication
(10) Pub. No.: US 2026/0327970 A1
(43) Pub. Date: Oct. 22, 2026

(54) MODULE FOR PLANT CONFIGURATION AND METHOD OF CONSTRUCTING PLANT

(71) Applicant: JGC CORPORATION, Kanagawa (JP)

(72) Inventors: Hiroki TAKAHASHI, Kanagawa (JP); Ryota IKEYA, Kanagawa (JP)

(73) Assignee: JGC CORPORATION, Kanagawa (JP)

(21) Appl. No.: 19/111,315

(22) PCT Filed: Sep. 30, 2022
(86) PCT No.: PCT/JP2022/036680

§ 371 Date: Mar. 13, 2025

(51) Int. Cl. E04B 1/348; F16L 3/22; H02G 3/04

(52) U.S. Cl. CPC E04B 1/34869; E04B 1/34815; F16L 3/22; H02G 3/0456

(57) ABSTRACT

A module for plant configuration of the present disclosure includes: in the module for plant configuration that is a first module of a plant configured by connecting the first module including a first pipe and a first cable rack provided on a first frame and a second module including a second pipe and a second cable rack provided on a second frame, the first frame; the first pipes provided in a plurality of stages at a rear end of the first frame so that the second pipes are connected from the rear, and each of the first pipes extending in a front-rear direction; and the first cable rack provided at the rear end of the first frame so that the second cable rack is connected from the rear, and having a different position in a right-left direction from the first pipes.

### TECHNICAL FIELD

The present invention relates to a technique for constructing a plant.

### BACKGROUND ART

When a plant is constructed, a method called module method is sometimes used to reduce operation on a construction site. To describe an outline of this method, a plurality of blocks that configures the plant is individually assembled as modules at a place called a module yard away from the construction site of the plant. Then, in the module method, each module is transported and installed to the construction site of the plant by a transport ship or the like, and the modules are connected to each other to complete the plant. The connection operation between the modules at the construction site includes connection operation of pipes between the modules, laying operation of cables for instrumentation across a plurality of modules, and the like. Patent Literature 1 discloses a natural gas (NG) plant constructed by a module method.

### CITATION LIST

### Patent Literature

Patent Literature 1: WO 2019/008725

### SUMMARY OF INVENTION

### Technical Problem

The present invention provides a technique capable of shortening a construction period required for construction of a plant.

### Solution to Problem

A module for plant configured of the present invention (first invention) includes:
in the module for plant configuration that is a first module of a plant configured by connecting the first module including a first pipe and a first cable rack provided on a first frame and a second module including a second pipe and a second cable rack provided on a second frame,
the first frame;
the first pipes provided in a plurality of stages at a rear end of the first frame so that the second pipes are connected from the rear, and each of the first pipes extending in a front-rear direction; and
the first cable rack provided at the rear end of the first frame so that the second cable rack is connected from the rear, and having a different position in a right-left direction from the first pipes.

The second invention is the module for plant configuration according to the first invention, in which the first pipe is not provided at a position vertically overlapping the first cable rack.

The third invention is the module for plant configuration according to the first invention, in which
a plurality of the first cable racks is provided, and
each of the first pipes has a different position in the right-left direction from each of the plurality of first cable racks.

The fourth invention is the module for plant configuration according to the third invention, in which
the first pipe is provided on each of right and left sides of the first cable rack, and
the first pipe is not provided between the first cable rack located closest to one side of the right and left sides and the first cable rack located closest to another side of the right and left sides.

The fifth invention is the module for plant configuration according to the third invention, in which the first cable rack located closest to the one side of the right and left sides is located on the other side of the first pipe located closest to the other side of the right and left sides of the first pipes.

The sixth invention is the module for plant configuration according to the first invention, in which
the second module constitutes a pipe rack extending in the right-left direction,
the plant includes a plurality of equipment modules arranged along an extending direction of the pipe rack, each of the equipment modules including equipment constituting the plant, and
the first module is the equipment module.

The seventh invention is the module for plant configuration according to the first invention, in which
the plant includes a pipe rack extending in a right-left direction, and
a plurality of equipment modules provided so as to be arrayed along an extending direction of the pipe rack, each of the equipment modules including equipment constituting the plant, and
the first module and the second module are modules arrayed in the right-left direction to form the pipe rack.

A method of constructing a plant according to the present invention (eighth invention) is
a method of constructing a plant including a first module including a first pipe and a first cable rack provided on a first frame, and a second module including a second pipe and a second cable rack provided on a second frame and connected to the second module, in which
the first pipes are provided in a plurality of stages at a rear end of the first frame and each of the first pipes extends in a front-rear direction, and a plurality of the first cable racks is provided at the rear end of the first frame to have different positions in a right-left direction from the first pipes, and
the method includes:
a process of installing the first frame and the second frame in a construction site of the plant such that the first frame and the second frame are arranged in a front-rear direction each other, and the first cable rack located closest to one side of the right and left sides of the first cable racks is located on the other side of the first pipe located closest to the other side of the right and left sides of the first pipes;
a process of next arranging a crane on one side of the right and left sides with respect to the first frame;
a process of next connecting the first pipe and the second pipe located at a rear of the first pipe by the crane; and
a process of connecting the first cable rack and the second cable rack located at a rear of the first cable rack.

### Advantageous Effects of Invention

The present invention can shorten a construction period required for construction of a plant.

### BRIEF DESCRIPTION OF DRAWINGS

FIG. 1 is a schematic plan view of an NG plant according to an embodiment of the present invention.

FIG. 2 is a side view in an X direction of a pipe rack forming module and an equipment module before connection that configurate the NG plant.

FIG. 3 is a perspective view of ends of the pipe rack forming module and the equipment module.

FIG. 4 is a plan view of the NG plant during connection operation of the equipment module.

FIG. 5 is a plan view of the NG plant during connection operation of the equipment module.

FIG. 6 is a side view of the equipment module in a Y direction.

FIG. 7 is a side view of the equipment module in the Y direction.

FIG. 8 is a side view of the equipment module in the Y direction.

FIG. 9 is a side view of the equipment module in the Y direction.

### DESCRIPTION OF EMBODIMENTS

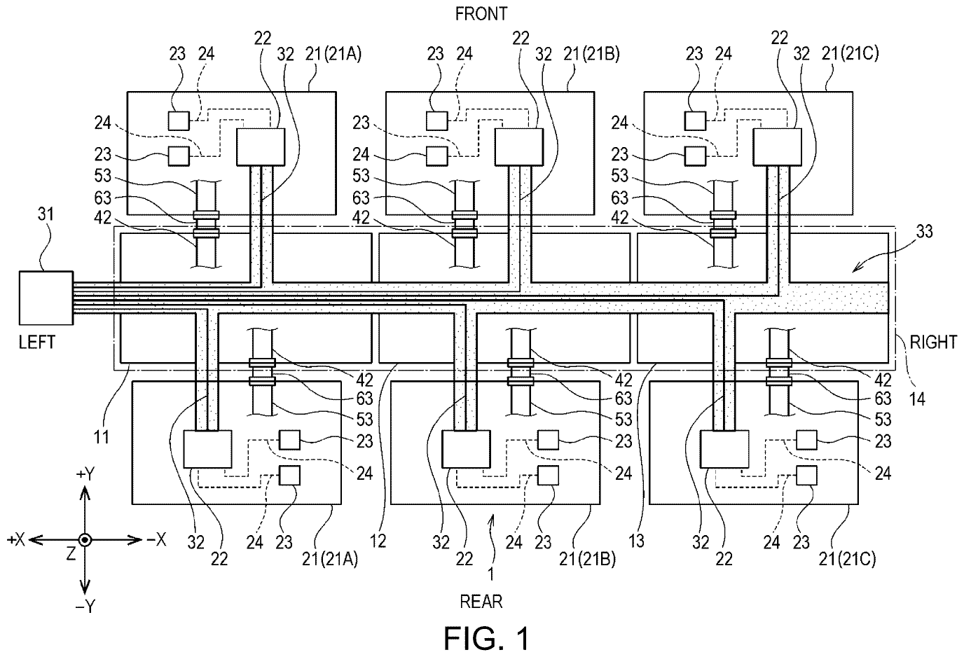

An NG plant 1 according to an embodiment of the present invention will be described with reference to a schematic plan view of FIG. 1. The NG plant 1 is a plant constructed by a module method, and cools and liquefies a natural gas (NG) produced from a gas well and stores the NG as a liquefied natural gas (LNG). Each module in the present embodiment includes a frame, equipment (rotating equipment and/or static equipment), pipes, and a cable rack that supports cables. The frame is formed by, for example, joining steel frames, and pipes and cable racks are accommodated and provided in the frame.

In the present specification, a horizontal direction is indicated as an X direction and a Y direction, and a vertical direction is indicated as a Z direction. Therefore, the X direction and the Y direction are lateral directions. The X, Y, and Z directions are orthogonal to one another. In addition, description will be given assuming that one end side and the other end side in the X direction are +X side and −X side, respectively, and one end side and the other end side in the Y direction are +Y side and −Y side, respectively. Note that the directions given in the description for each module that configures the NG plant 1 are directions in a state where the module is installed in a construction site of the NG plant 1. That is, even in a case where a module being assembled in a module yard is described, the directions given in the description are directions in the state where the module is installed in the construction site to form the NG plant 1.

Note that, to prevent complication of the description, the configuration of the plant is more simplified than the actual configuration in the following description. Specifically, the number of modules and the number of cables that configurate the plant are reduced, and a structure of a frame included in the module is simplified.

The NG plant 1 includes a plurality of pipe rack forming modules and a plurality of equipment modules. The pipe rack forming modules 11 to 13 are arranged in the X direction, and the pipe rack forming modules 11, 12, and 13 are arranged in this order from the +X side to the −X side. Then, adjacent modules of the pipe rack forming module 11 to 13 are connected to each other to form a pipe rack 14 extending in the X direction.

Then, three equipment modules 21 are provided on each of the +Y side and the −Y side with respect to the pipe rack 14. Then, the three equipment modules 21 on the +Y side and the three equipment modules 21 on the −Y side are arranged at intervals along the X direction (that is, along an extending direction of the pipe rack 14). These equipment modules 21 are provided with the static equipment and the rotating equipment accommodated in the frame. An example of the static equipment includes a tower tank 52 (not illustrated in FIG. 1) that causes various reactions such as distillation, desulfurization, and dehydration and stores reaction products. An example of the rotating equipment includes a pump (not illustrated) that allows a fluid (gas or liquid) to flow between the modules to perform necessary processing in the plant.

The pipes provided in the respective equipment modules 21 are connected to each other via the pipe provided in the pipe rack 14 so that the fluid (gas or liquid) necessary for the processing in the NG plant 1 flows between the equipment modules 21. Note that the pump provided in the equipment module 21 is used to move the fluid between the equipment modules 21, and the flow of the fluid between a pipe 42 of the pipe rack 14 and a pipe 53 of the equipment module 21, which are connected to each other as will be described below, is also performed by the pump. In the NG plant 1, the natural gas is transferred through the tower tank 52 of each equipment module 21 and undergoes processing, and is stored as the LNG in the tower tank 52 (storage tank) of the equipment module 52 that the natural gas has been transferred last.

Note that the three equipment modules 21 arranged in the X direction as described above may be distinguished from one another as 21A, 21B, and 21C in order toward the −X side. The equipment modules 21A, 21B, and 21C are adjacent to the pipe rack forming modules 11, 12, and 13, respectively, and the adjacent pipe rack forming module and the equipment module are connected to each other.

An instrument room 31 is provided on the +X side with respect to the pipe rack 14. The instrument room 31 is provided with an instrumentation panel and a control panel in which various types of equipment for performing various types of measurement, monitoring, and control for static equipment and the rotating equipment are stored. In addition, a control room for an operator to operate the equipment of the NG plant 1 is provided separately from the instrument room 31, but illustration is omitted.

The above-described equipment module 21 is provided with a junction box (JB) 22 and an instrumentation device 23. A large number of instrumentation devices 23 is provided in each equipment module 21, but only two are displayed for convenience. Each of the instrumentation devices 23 is a thermometer, a flow meter, a pressure gauge, a liquid level gauge, a vibratory meter, or the like. In each equipment module 21, the JB 22 and each instrumentation device 23 are connected to each other by a single-core cable 24. The instrument room 31 and the JB 22 of each equipment module 21 are connected by a cable 32 that is a multi-core cable. Therefore, the cables 24 and 32 are instrumentation cables.

In the NG plant 1, a laying region 33 in which the cable 32 is laid extends from the instrument room 31 toward the −X side of the pipe rack 14. The laying region 33 is formed by the cable rack that supports the cable 32. The laying region 33 branches in the middle of extending to the −X side as described above, and is directed in each of the +Y direction and the −Y direction in the pipe rack 14. Hereinafter, description will be given referring to a portion extending in the X direction as a trunk, and a portion branching from the trunk as a branch in the laying region 33.

A large number of cables 32 collectively extend from the instrument room 31 toward the −X side of the pipe rack 14 along the trunk of the laying region 33. Each cable 32 is bent at a position corresponding to a position of the equipment module 21 to be connected, drawn out to the branch of the laying region 33, and connected to the JB 22 of the equipment module 21 described above. As described above, the large number of instrumentation cables 32 extending from the instrument room 31 include a power supply cable (that is, an AC cable) that supplies power to the instrumentation device 23 and a signal cable (that is, a DC cable) that transmits a signal from the instrumentation device 23 to the instrument room 31.

In FIG. 1, one laying region 33 is displayed, and one of the branches of the laying region 33 is connected to the JB 22 provided in the equipment module 21. However, in reality, a plurality of the laying regions 33 and a plurality of the JBs 22 in one equipment module 21 are provided. Therefore, a plurality of branches of the laying regions 33 extends toward one equipment module 21, and the cables 32 are connected to the plurality of JBs 22 of the equipment module 21 via the respective branches. To prevent generation of noise in the signal, at least the DC cable and the AC cable are provided in different laying regions 33 so as to be located apart from each other.

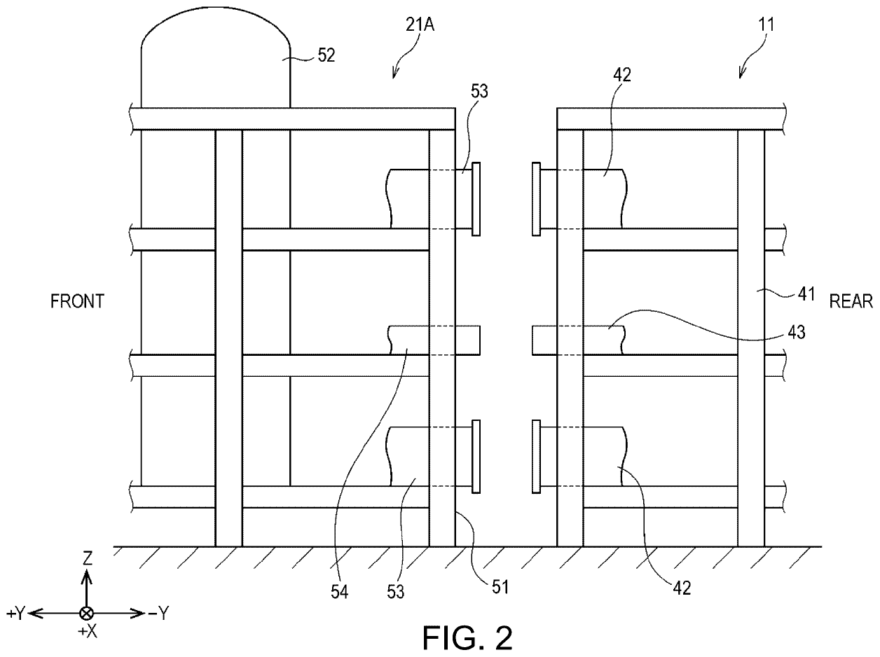

FIG. 2 is a side view of the pipe rack forming module 11 and the equipment module 21A as viewed in the X direction, and illustrates a state after being installed in the construction site of the NG plant 1 and before being connected to each other. The pipe rack forming module 11 includes a frame 41. Struts and beams that configurate the frame 41 form pipe arrangement regions at different positions in the Z direction in the frame 41. At each of the +Y side end and the −Y side end of the frame 41, an end of the pipe 42 extends in the Y direction and the pipes 42 are provided in a plurality of stages. Note that FIG. 2 illustrates only the end of the pipe 42 on the +Y side. The pipe 42 is a pipe connected to the pipe 53 to be described below in the equipment module 21A.

A cable tray 43, which is a tray-type cable rack, is provided as a cable rack for forming the branch of the laying region 33 at the +Y side end and the −Y side end of the frame 41. Note that FIG. 2 illustrates only the cable tray 43 on the +Y side. In the cable tray 43, both ends in a width direction of a long plate are bent in the same direction to form a recess. After the cable tray 43 is connected to a cable tray 54 to be described below of the equipment module 21A, the cable 32 is laid in the recess along a length direction of the cable tray 43. The cable tray 43 is arranged to extend in the Y direction toward the equipment module 21A.

Next, the equipment module 21A will be described. The equipment module 21A is provided with a frame 51, and the tower tank 52 is accommodated in the frame 51. Further, struts and beams that configurate the frame 51 form pipe arrangement regions at different positions in the Z direction in the frame 51. That is, similarly to the frame 41, the pipes are arranged in a plurality of stages. Then, at the end of the frame 51 on the side facing the pipe rack forming module 11, the end of the pipe 53 extends in the Y direction and the pipes 53 are provided in a plurality of stages. The end of the pipe 53 faces the end of the pipe 42 so as to be connected to the pipe 42 of the pipe rack forming module 11.

Frame, the frame 51 is provided with the cable tray 54. The cable tray 54 is configured similarly to the cable tray 43 in the pipe rack forming module 11, and forms the branch of the laying region 33. Then, the cable tray 54 extends in the Y direction toward the pipe rack forming module 11 and faces the cable tray 43. After the connection with the cable tray 43, the cable 32 is laid along the extending direction of the cable tray 54.

The pipe rack forming modules 12 and 13 have a similar configuration to the pipe rack forming module 11 except that the ends of the pipes 42 and the cable trays 43 extend toward the equipment modules 21B and 21C, respectively. The equipment modules 21B and 21C have a same configuration to the equipment module 21A except that the ends of the pipes 53 and the cable trays 54 extend toward the pipe rack forming modules 12 and 13, respectively.

The equipment module 21 is a first module, the frame 51 in the equipment module 21 is a first frame, the pipe 53 is a first pipe, and the cable tray 54 is a first cable rack. Further, the pipe rack forming modules 11 to 13 are second modules, the frames 41 in the pipe rack forming modules 11 to 13 are second frames, the pipes 42 are second pipes, and the cable trays 43 are second cable racks. Then, in a case where the connection between the equipment module 21 and the pipe rack 14 is viewed, the X direction is a right-left direction, and the Y direction is a front-rear direction. In a case where the equipment modules 21 and the pipe rack forming modules 11 to 13 connected to each other are viewed in the front-rear direction, the side on which the equipment modules 21 are located is a front side, and the side on which the pipe rack forming modules 11 to 13 are located is a rear side.

The description of the directions is supplemented. In each drawing, regarding the directions of the plant, the +Y side, the −Y side, the +X side, and the −X side are indicated as the front side, the rear side, the left side, and the right side, respectively. Connection between modules will be described below, focusing on the connection between the equipment module 21 (first module) arranged on the +Y side (front side) and the module (second module) constituting the pipe rack 14 arranged on the −Y side (rear side). Note that the front, rear, left, and right directions in the drawings are for convenience. In connecting the first module and the second module, the side on which the first module is located is the front in claims, and the side on which the second module is located is the rear in claims. That is, when considering the connection between the equipment module 21 (first module) arranged on the −Y side and the module (second module) forming the pipe rack 14, the −Y side is the front side and the +Y side is the rear side.

A construction process of the above-described NG plant 1 will be described. The pipe rack forming module 11 to 13 and the equipment modules 21 are assembled in the module yard. Assembly operation of the modules includes formation of the frames constituting the modules, installation of various pipes, the rotating equipment, the static equipment, the JBs 22, the instrumentation devices 23, and the like on the frames, connection of the JBs 22 and the instrumentation devices 23 by the cables 24, and installation of the cable rack for forming the laying region 33. During this assembly, a temporary scaffold is assembled around each module, and the scaffold is used. Note that the temporary scaffold is dismantled and removed after the assembly of the modules is completed, for reasons such as differences in standards and regulations regarding the scaffold between the module yard and the construction site of the NG plant 1.

The pipe rack forming modules 11 to 13 are transported to and installed in the construction site of the plant. Then, the pipes are connected and the cable racks are connected between the adjacent modules of the pipe rack forming module 11 to 13, so that the adjacent modules are connected to form the pipe rack 14. Note that the connection of the cable racks among the pipe rack forming modules 11 to 13 is operation of forming the trunk of the laying region 33 described in FIG. 1.

Thereafter, the equipment modules 21 are transported to and installed in the construction site of the NG plant 1. FIG. 1 illustrates a space between the equipment modules 21 arranged in the X direction to be relatively large, but in reality, this space is relatively small. Therefore, to prevent interference between the equipment modules 21 arranged in the X direction, transportation and installation of the equipment modules 21 are sequentially performed from one side to the other side in the X direction for each of the +Y side and the −Y side with respect to the pipe rack 14. Specifically, for example, the equipment modules 21A, 21B, and 21C are transported to and installed in the construction site in this order.

As for the equipment module 21 and the pipe rack 14 installed in this manner, the end of the pipe 42 and the end of the pipe 53 face each other with a space therebetween, and the cable tray 43 and the cable tray 54 face each other with a space therebetween, as illustrated in FIG. 2. By performing the connection between the pipes 42 and 53 and the connection between the cable trays 43 and 54 facing each other in this manner, the equipment module 21 and the pipe rack 14 are connected.

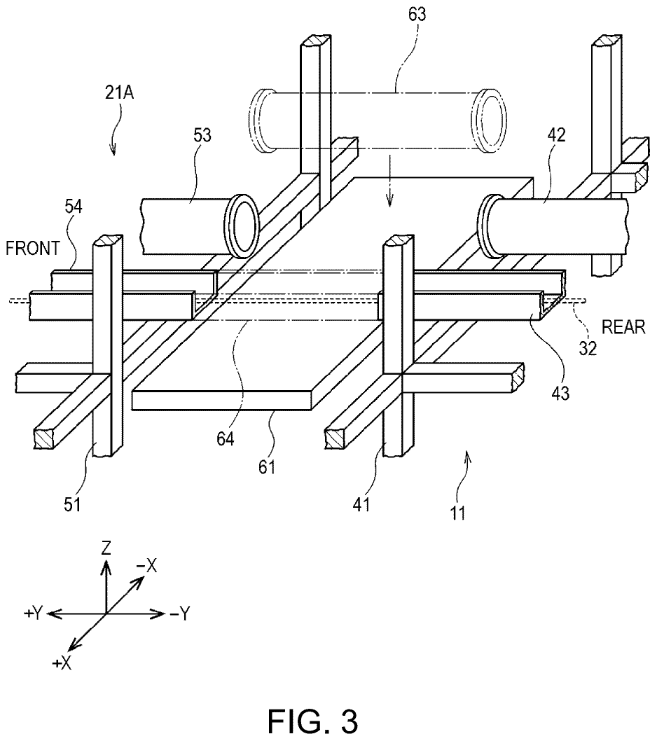

Pipe connection operation and cable tray connection operation between the equipment module 21A and the pipe rack forming module 11 will be described with reference to FIG. 3, which is a perspective view of these modules. A temporary scaffold 61 is assembled between the pipe rack forming module 11 and the equipment module 21A. Then, the pipe (referred to as connection pipe 63) is lifted by a crane 62 (not illustrated in FIG. 3) and inserted between the pipe 42 of the pipe rack forming module 11 and the pipe 53 of the equipment module 21A. Then, an operator welds the connection pipe 63 to each of the pipes 42 and 53 using the scaffold 61. That is, the pipes 42 and 53 are connected via the connection pipe 63.

Further, the operator inserts a cable tray (referred to as connection cable tray 64) between the cable trays 43 and 54 and connects the cable trays 43 and 54 by a predetermined method, using the scaffold 61. The connection cable tray 64 has a similar configuration to the cable trays 43 and 54, and is connected so as to extend in the Y direction similarly to the cable trays 43 and 54. Therefore, the cable trays 43 and 54 are connected such that the cable trays 43 and 54 and the connection cable tray 64 form a continuous cable tray. Note that the connection between the cable trays 43 and 54 is operation of forming the branches of the laying region 33 illustrated in FIG. 1. Further, the connection cable tray 64 is lighter than the connection pipe 63, and the insertion between the cable trays 43 and 54 is manually performed by the operator without using the crane 62.

After connecting the cable trays 43 and 54, the operator lays a distal end side of the cable 32, which has been laid from the instrument room 31 along the trunk of the laying region 33, along the branch of the laying region 33, and connects the distal end of the cable 32 to the JB 22 of the equipment module 21A. Although the connection of the equipment module 21A to the pipe rack forming module 11 has been described as a representative example, each of the equipment modules 21B and 21C is also connected to the pipe rack forming modules 12 and 13, similarly to the equipment module 21A. For the connection between the modules, temporary scaffolds are assembled at various places in addition to the scaffold 61, but after completion of the connection operation, these temporary scaffolds including the scaffold 61 are disassembled and removed, and operation of the NG plant 1 is started.

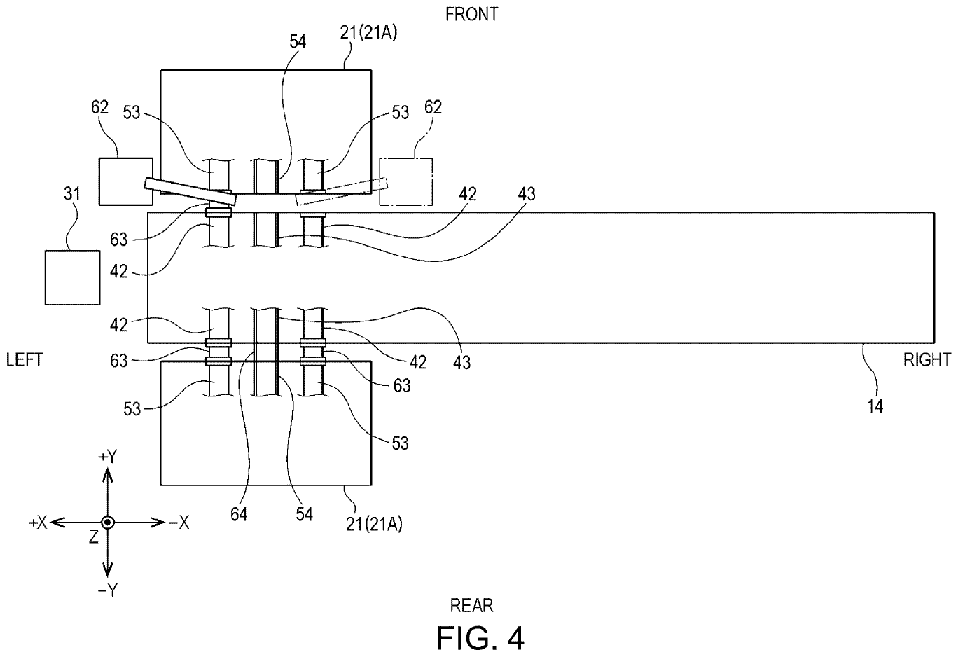

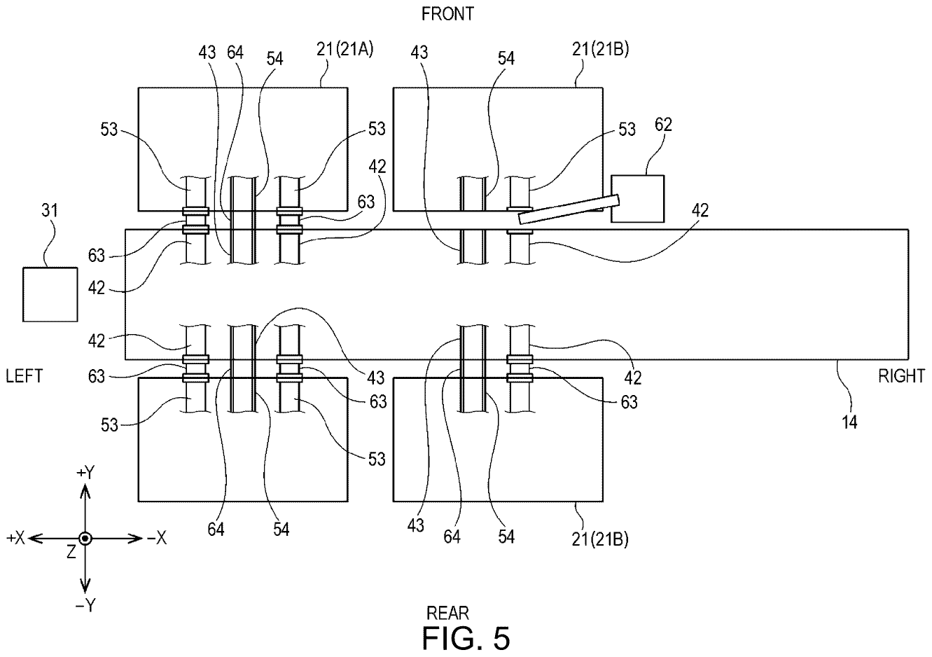

The pipe connection operation between the pipe rack 14 and the equipment module 21 will be supplemented. Regarding the equipment modules 21 arranged in the X direction, after one equipment module 21 is installed in the construction site of the plant, the pipe connection operation of the one equipment module 21 is performed before the next equipment module 21 is installed in the construction site in order to secure an installation space of the crane 62. Specifically, with reference to FIGS. 4 and 5, which are schematic plan views illustrating the construction process of the NG plant 1, regarding the equipment modules 21A, 21B, and 21C in the same row in the X direction, the pipe connection operation for 21A is performed before the equipment module 21B is installed, and the pipe connection operation for 21B is performed before the equipment module 21C is installed.

Then, as for the pipe connection operation for the equipment module 21A, since the equipment module 21 is not installed on the +X side and the −X side, the operation can be performed by arranging the cranes 62 on the +X side and the −X side, respectively, with respect to the equipment module 21A (see FIG. 4). A layout of the pipes 42 and 53 of the equipment module 21A and the pipe rack 14 is set so that the connection operation can be performed by the cranes 62 arranged on the +X side and the −X side, respectively.

Regarding the pipe connection operation for the equipment modules 21B and 21C, since the equipment module 21 is installed on the +X side, the crane 62 cannot be arranged on the +X side, so that the operation is performed by arranging the crane 62 only on the −X side (see FIG. 5). A layout of the pipes 42 and 53 of the equipment modules 21B and 21C and the pipe rack 14 is set so that the connection operation can be performed by the crane 62 arranged on the −X side.

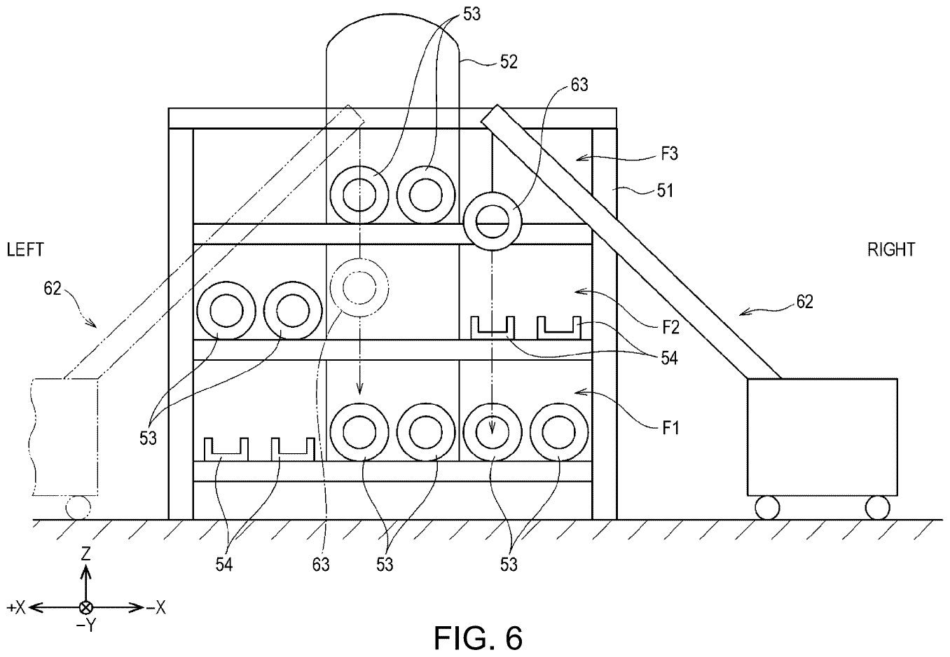

The layout of the pipe 53 and the cable tray 54 will be described with reference to FIG. 6 illustrating a layout of a comparative example. Note that each of FIG. 6 and the subsequent drawings is a side view of the equipment module 21 located on the +Y side (front side) with respect to the pipe rack 14 as viewed toward the +Y side (front side), and illustrates the end on the −Y side (rear side) of the equipment module 21. The equipment module 21 in each drawing is illustrated as having three layers formed by the frame 51, which are layers F1, F2, and F3 in order from the bottom, and a plurality of ends of the pipes 53 are installed in each of the layers F1 to F3.

FIG. 6 illustrates a layout of a comparative example of the equipment module 21A. In this comparative example, a plurality of the cable trays 54 is arranged in each of the layers F1 and F2. Then, in the layer F1, the +X side (left side) is an installation area for the cable trays 54, and a central portion and the −X side (right side) are installation areas for the ends of the pipes 53 in the X direction. In the layer F2, the +X side is the installation area for the ends of the pipes 53, and the −X side is the installation area for the cable trays 54. In the layer F3, the central portion in the X direction is the installation area for the ends of the pipes 53. Therefore, between the layers F1 and F2, the ends of the pipes 53 and the cable trays 54 overlap in the Z direction.

As illustrated in FIG. 6, in performing the pipe connection operation for the equipment module 21A, the cranes 62 are arranged on the +X side and the −X side, respectively, with respect to the equipment module 21A. Then, the connection operation is performed by the crane 62 arranged on the +X side with respect to the equipment module 21A, for the pipe 53 located closer to +X, and the connection operation is performed by the crane 62 arranged on the −X side with respect to the equipment module 21A, for the pipe 53 located closer to −X. To shorten a construction period of the NG plant 1, it is effective to perform the connection operation between the cable tray 54 and the cable tray 43 of the pipe rack forming module and the laying operation of the cable 32 on the connected cable trays 43 and 54 in parallel with the connection operation between the pipe 53 and the pipe 44 of the pipe rack forming module 11.

However, the connection pipe 63 lifted by the crane 62 is relatively heavy. Therefore, to ensure the safety of the operator, it is avoided that the operator performs the connection operation of the cable tray and the laying operation of the cable 32 under the lifted connection pipe 63 and the crane 62. Therefore, the connection operation and the laying operation of the cable 32 cannot be performed on the cable tray 54 provided in the area overlapping the end of the pipe 53 in the Z direction until the connection operation of the pipe 53 is completed. Specifically, since each of the cable tray 54 on the +X side of the layer F1 and the cable tray 54 on the −X side of the layer F2 overlaps the ends of the pipes 53 in the Z direction, the connection operation and the laying operation of the cable 32 cannot be performed.

Further, when the connection operation is performed for the pipe 53 closer to the +X side in the central portion in the X direction of the layer F1, the crane 62 is located above the cable tray 54 on the +X side of the layer F1 as indicated by the chain line in the drawing. Therefore, for the cable tray 54 on the +X side of the layer F1, the connection operation cannot be promptly started due to the end of the pipe 53 being located on the −X side in the same layer in addition to the end of the pipe 53 being installed above, and the connection operation of the cable tray 54 is performed after completion of the connection operation of the pipes 53.

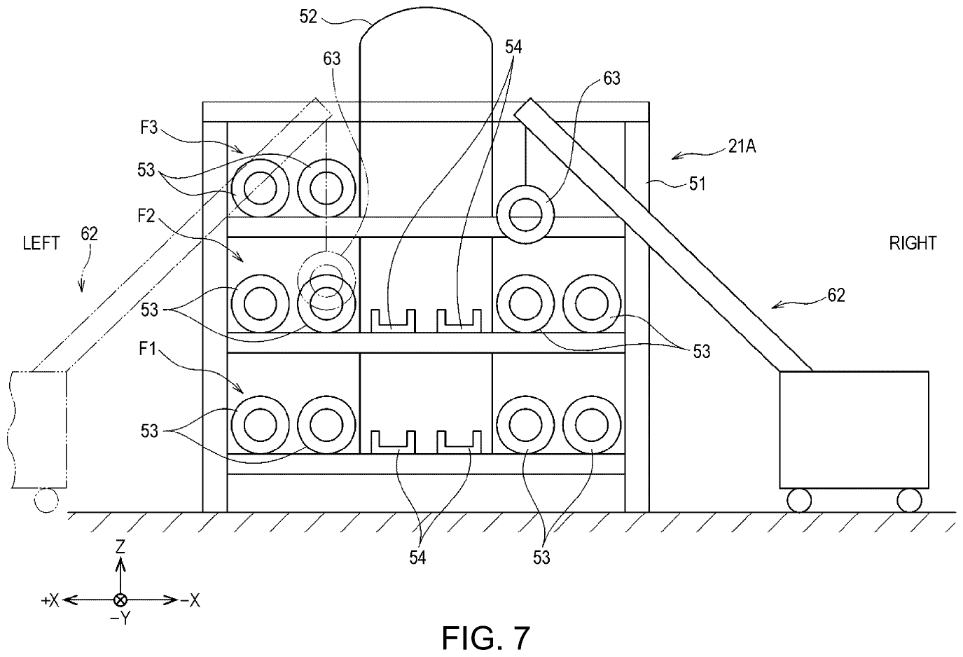

Next, the layout of the pipe 53 and the cable tray 54 at the −Y side end of the equipment module 21A according to a first example of the present invention will be described with reference to FIG. 7, focusing on differences from the comparative example. In the layers F1 and F2, the ends of the pipes 53 are installed at the +X side (left side) end and the −X side (right side) end, respectively, and in the layer F3, the end of the pipe 53 is installed at the +X side end. Then, in the layers F1 and F2, a plurality of the cable trays 54 is arranged side by side in the X direction in the central portion in the X direction. Therefore, in each of the layers F1 and F2, each cable tray 54 is sandwiched between the pipes 53 from the +X side (left side) and the −X side (right side), and has a different position in the right-left direction from each pipe 53. More specifically, the arrangement area of the pipe 53 does not overlap the cable tray 54 in the Z direction. That is, the end of the pipe 53 is not provided at a position vertically overlapping the cable tray 54. More specifically describing the layout, the end of the pipe 53 is provided on each of the +X side and the −X side with respect to each cable tray 54. Then, the end of the pipe 53 is not provided between the cable tray 54 located closest to the +X side and the cable tray 54 located closest to the −X side in the X direction.

The connection operation is performed for each pipe 53 located at the +X side end of the equipment module 21A by the crane 62 (indicated by the chain line in FIG. 7) arranged on the +side with respect to the equipment module 21A. The connection operation is performed for each pipe 53 located at the −X side end of the equipment module 21A by the crane 62 (indicated by the solid line in FIG. 7) arranged on the −X side of the equipment module 21A. Then, with such a layout of the pipes 53 and the cable trays 54, the crane 62 located on one side of the +X side and the −X side does not move from the one side to the other side across the cable trays 54 during the connection operation.

As described above, in the layout of the equipment module 21A of the first example, the crane 62 is prevented from being arranged at the position overlapping the cable tray 54 in the Z direction when the connection operation of any of the pipes 53 is performed. Therefore, the connection operation of each cable tray 54 and the laying operation of the cable 32 on the connected cable tray 54 can be performed in parallel with the connection operation of each pipe 53. Note that the connection operation may be performed for one of the +X-side pipe 53 and the −X side pipe 53 first, or may be performed in parallel.

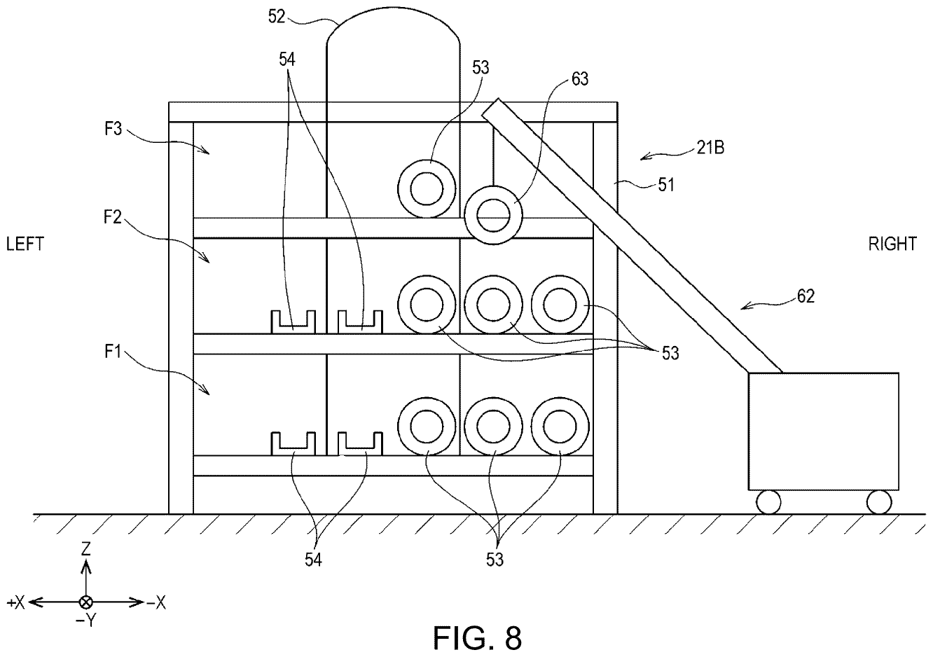

Next, as a second example, the layout of the end of the pipe 53 and the cable tray 54 in an equipment module 21B will be described with reference to FIG. 8, mainly focusing on differences from the equipment module 21A of the first example. In the layers F1 to F3, the ends of the pipes 53 are provided at positions closer to the −X side of the equipment module 21B. Then, in the layers F1 and F2, each cable tray 54 is provided on the +X side with respect to the end of the pipe 53. More specifically, the cable tray 54 provided on the −X side is located closest to the +X side with respect to the end of the pipe 53 located closest to the +X side.

Therefore, in the second example, the end of the pipe 53 and the cable tray 54 do not overlap each other in the Z direction, as in the first example. Then, in performing the connection operation of the pipe 53 as described with reference to FIG. 5, the crane 62 is arranged on the −X side with respect to the equipment module 21B, but since the pipes 53 are gathered on the −X side, the crane 62 is not located on the +X side beyond an area where the pipes 53 are located. Therefore, in the equipment module 21B of the second example, the crane 62 is not located above the cable tray 54 during the connection operation of each pipe 53, similarly to the equipment module 21A of the first example. Therefore, the connection operation of each cable tray 54 and the laying operation of the cable 32 on the connected cable tray 54 can be performed in parallel with the connection operation of each pipe 53.

Note that, as for the equipment module 21C installed on the +Y side with respect to the pipe rack 14, the operation by the crane 62 is performed similarly to the equipment module 21B illustrated in FIG. 8, and thus, the layout thereof is similar to that of the equipment module 21B. Then, the connection operation of the cable tray 54 and the laying operation of the cable 32 are performed in parallel with the connection operation of the pipe 53. Further, the equipment modules 21A to 21C installed on the −Y side (rear side) with respect to the pipe rack 14 have a layout of the ends of the pipes 53 and the cable trays 54, similar to the equipment modules 21A to 21C on the +Y side (front side) of the pipe rack 14, and the connection operation of the cable trays 54 and the laying operation of the cables 32 are performed in parallel with the connection operation of the pipes 53.

In the NG plant 1 including the equipment modules 21A to 21C of the above examples, the connection operation of each cable tray 54 and the laying operation of the cable 32 on the connected cable tray 54 can be performed in parallel with the connection operation of each pipe 53. Therefore, the construction period for the NG plant 1 can be shortened.

Note that, as described with reference to FIG. 2, the end of the pipe 42 and the end of the pipe 53 face each other and the cable tray 43 and the cable tray 54 face each other between the pipe rack 14 and the equipment module 21. Therefore, setting the layout of the pipe 53 and the cable tray 54 of the equipment module 21 as described with reference to FIGS. 7 and 8 sets the layout of the pipe 42 and the cable tray 43 in the pipe rack 14 so as to correspond to the layout of the pipe 53 and the cable tray 54. Therefore, although it has been described that the equipment module 21 is the first module of the present invention, it can also be seen that the first module is the pipe rack forming modules 11 to 13.

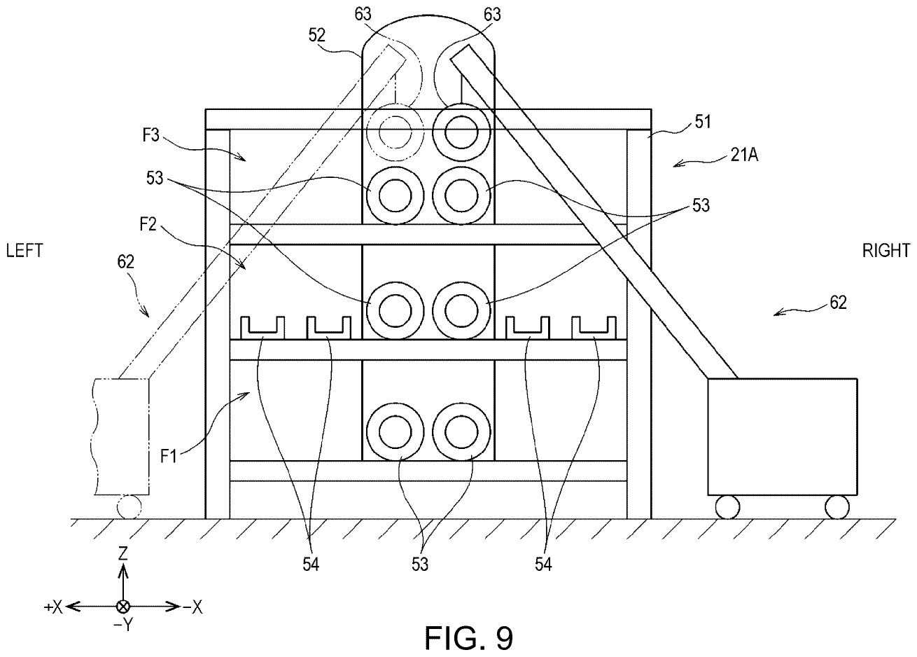

A layout of the pipes 53 and the cable trays 54 of the equipment module 21A is illustrated in FIG. 9 as a third example, and the layout of the third example will be described focusing on differences from the layout of the first example. In the third example, in the layers F1 to F3, the end of each pipe 53 is located in the central portion of the equipment module 21A in the X direction. Then, in the layer F2, the cable trays 54 are provided at the +X side end and the −X side end of the equipment module 21A, and the end of the pipe 53 is not provided at a position overlapping each cable trays 54 in the Z direction. More specifically describing the layout, the cable tray 54 is not provided between the end of the pipe 53 located closest to the +X side and the end of the pipe 53 located closest to the −X side.

In the third example, the crane 62 is sequentially arranged on one side and the other side of the +X side (left side) and the −X side (right side) with respect to the equipment module 21A, and each pipe 53 is connected. Then, the connection operation and the laying operation of the cable 32 for the cable tray 54 are performed in parallel with the connection operation of the pipe 53. Specifically, assuming that one side is the +X side and the other side is the −X side, first, the crane 62 is arranged on the +X side (one side) as indicated by the chain line in the drawing, and the connection operation of each pipe 53 closer to +X in the central portion in the X direction of the equipment module 21A is performed. At this time, since the cable tray 54 arranged on the +X side in the equipment module 21A is located below the crane 62, the connection operation and the laying operation of the cable 32 for each cable tray 54 on the +X side cannot be performed. However, since the crane 62 is not located above each cable tray 54 arranged on the −X side in the equipment module 21A, the connection operation and the laying operation of the cable 32 for the cable tray 54 on the −X side is performed in parallel with the connection operation of the pipe 53.

Then, when the connection operation of the pipe 53 closer to +X in the central portion in the X direction is completed, the crane 62 is moved to the −X side (the other side) of the equipment module 21A as indicated by the solid line in the drawing, and the connection operation of each pipe 53 closer to −X in the central portion in the X direction of the equipment module 21A is performed. While the connection operation of the pipe 53 closer to the −X side is performed after the crane 62 is moved to the −X side, the crane 62 is not located above each cable tray 54 arranged on the +X side of the equipment module 21A. Therefore, the connection operation and the laying operation of the cable 32 for the cable tray 54 on the +X side are performed in parallel with the movement of the crane 62 to the −X side of the module and the connection operation of the pipe 53 closer to the −X side.

Even in the third example, the connection operation of the pipe 53, the connection operation of the cable tray 54, and the laying operation of the cable 32 can be performed in parallel. Thus, the construction period of the NG plant 1 can be shortened. Note that, since the operation on some of the cable trays 54 is restricted by the connection operation of the pipe 53 as described above, the layout of the first example can more reliably shorten the construction period, which is favorable.

In the first to third examples, the layout in which the pipes 53 do not overlap any of the cable trays 54 in the Z direction has been adopted, but a layout in which the pipes 53 do not overlap only some of the cable trays 54 in the Z direction may be adopted. As a specific example, the pipe 53 is provided at the +X side end in the layer F1 or F3 of the third example in FIG. 9 so as to overlap the cable tray 54. Then, as described above, when the crane 62 is arranged on the +X side of the equipment module 21A when the connection operation is performed in order of the +X side pipe 53 and the −X side pipe 53 of the equipment module 21A, the connection operation is also performed for the pipes 53 on the +X side end of the layers F1 and F3 in addition to the pipe 53 closer to +X in the central portion of the module. In parallel with the connection operation of the pipes 53, the connection operation with respect to the cable tray 54 is performed on the −X side of the module as described above. Since the operations can be performed in parallel in this manner, the construction period of the NG plant 1 can be shortened. However, as in the first to third examples, it is favorable to provide the ends of the pipes 53 so as not to overlap all the cable trays 54 in the Z direction so that the operation for each cable tray 54 is not affected by the connection operation of the pipes 53 in order to more reliably shorten the construction period of the NG plant 1.

Although the connection between the equipment module 21 and the pipe rack 14 has been described so far, the connection between the pipe rack forming modules 11 to 13 may be similarly performed. That is, the layout of the pipes and cable trays for the ends of the adjacent pipe rack forming modules may be similarly set to the above-described each example, and the connection operation of the pipes, and the connection operation of the cable trays and the laying operation of the cables 32 may be performed in parallel. By doing so, the construction period of the NG plant 1 can be shortened. In this case, the first module and the second module connected to each other are modules adjacent to each other among the pipe rack forming modules 11 to 13, and the Y direction is the right-left direction and the X direction is the front-rear direction.

Note that, in the pipe rack 14, the pipes are relatively densely arranged, and the length of each pipe is relatively short so as not to hinder the processing. Due to this restriction, a pipe extending in the Y direction so as to be drawn out to the equipment module 21 has a higher degree of freedom in design than a pipe extending in the X direction between adjacent modules among the pipe rack forming modules 11 to 13. That is, there is little difficulty in plant design and it is advantageous to set the layout of the pipes and the cable trays by setting one of the pipe rack forming modules 11 to 13 and the equipment module 21 as the first module and the other as the second module (module connected to the first module).

Further, as described above, after the installation of the pipe rack forming modules 11 to 13 in the construction site, the installation of the equipment module 21 in the construction site is performed. Therefore, even if the connection operation of the cable tray is delayed with respect to the connection operation of the pipe among the pipe rack forming modules 11 to 13, the connection operation and the laying operation of the cable tray can be performed in parallel with the installation operation of the equipment module 21, so that the influence on the construction period of the NG plant 1 is suppressed. However, since the equipment module 21 is installed after the pipe rack forming modules 11 to 13, if the connection operation of the cable tray is delayed with respect to the connection operation of the pipe, the delay relatively greatly affects the construction period of the plant. Therefore, application of the present invention to the connection between the equipment module 21 and the pipe rack forming modules 11 to 13 is advantageous from the viewpoint of more reliably shortening the plant construction period.

Note that the description has been given using the cable tray as an example of the cable rack, but the shape of the cable rack is not limited to the example. As the cable rack other than the tray type, for example, a ladder type cable rack can be used.

In the NG plant 1, only the instrumentation cables 32 are provided in the laying region 33, and the power supply cables for supplying power to various types of rotating equipment such as pumps are laid in a region different from the laying region 33. However, the power supply cables of the rotating equipment may be provided in the laying region 33. Therefore, the above-described cable laying operation is not limited to the laying operation of the instrumentation cables 32.

Although the example in which one equipment module 21 is connected to each of the +Y side and the −Y side of one pipe rack forming module has been described, the number of equipment modules 21 connected to each of the +Y side and the −Y side is arbitrary. In addition, the present technology is not limited to being applied to an NG plant that generates LNG. For example, the present invention can be applied to various plants such as a petroleum refining plant that performs distillation, desulfurization, and the like for crude oil and various intermediate products, a chemical plant that performs production of petrochemical products, intermediate chemicals, polymers, and the like, and a plant that manufactures pharmaceuticals and foods. Therefore, the tower tank 52 included in the equipment module 21 may be, for example, a distillation tower, a rectification tower, an extraction tower, an absorption tower, a washing tower, a desulfurization tower, a regeneration tower, a reaction tower, a stirring tank, a fermentation tank, or a culture tank, which performs various reactions. Note that the equipment module 21 may be configured as the equipment module 21 by, for example, being assembled in a module yard in a state of being divided into a plurality of parts and connected to each other after being installed in the construction site.

It should be construed that embodiments disclosed herein are given by way of illustration in all respects, not by way of limitation. The above-described embodiments may be omitted, substituted, modified, or combined in various forms without departing from the scope and spirit of the appended claims.

### REFERENCE SIGNS LIST

11 to 13 Pipe rack forming module
21 Equipment module
41 Frame
42 Pipe
43 Cable tray
51 Frame
53 Pipe
54 Cable tray

1. A module for plant configuration that is a first module of a plant configured by connecting the first module including a first pipe and a first cable rack provided on a first frame and a second module including a second pipe and a second cable rack provided on a second frame, the module comprising:
the first frame;
the first pipes provided in a plurality of stages at a rear end of the first frame so that the second pipes are connected from the rear, and each of the first pipes extending in a front-rear direction; and
the first cable rack provided at the rear end of the first frame so that the second cable rack is connected from the rear, and having a different position in a right-left direction from the first pipes.

2. The module for plant configuration according to claim 1, wherein the first pipe is not provided at a position vertically overlapping the first cable rack.

3. The module for plant configuration according to claim 1, wherein
a plurality of the first cable racks is provided, and
each of the first pipes has a different position in the right-left direction from each of the plurality of first cable racks.

4. The module for plant configuration according to claim 3, wherein
the first pipe is provided on each of right and left sides of the first cable rack, and
the first pipe is not provided between the first cable rack located closest to one side of the right and left sides and the first cable rack located closest to another side of the right and left sides.

5. The module for plant configuration according to claim 3, wherein
the first cable rack located closest to the one side of the right and left sides of the first cable racks
is located on the other side of the first pipe located closest to the other side of the right and left sides of the first pipes.

6. The module for plant configuration according to claim 1, wherein
the second module constitutes a pipe rack extending in the right-left direction,
the plant includes a plurality of equipment modules arranged along an extending direction of the pipe rack, each of the equipment modules including equipment constituting the plant, and
the first module is the equipment module.

7. The module for plant configuration according to claim 1, wherein
the plant includes a pipe rack extending in a right-left direction, and
a plurality of equipment modules provided so as to be arrayed along an extending direction of the pipe rack, each of the equipment modules including equipment constituting the plant, and
the first module and the second module are modules arrayed in the right-left direction to form the pipe rack.

8. A method of constructing a plant including a first module including a first pipe and a first cable rack provided on a first frame, and a second module including a second pipe and a second cable rack provided on a second frame and connected to the first module, wherein
the first pipes are provided in a plurality of stages at a rear end of the first frame and each of the first pipes extends in a front-rear direction, and a plurality of the first cable racks is provided at the rear end of the first frame to have different positions in a right-left direction from the first pipes, and
the method comprises:
a process of installing the first frame and the second frame in a construction site of the plant such that the first frame and the second frame are arranged in a front-rear direction each other, and the first cable rack located closest to one side of right and left sides of the first cable racks is located on another side of the first pipe located closest to the other side of the right and left sides of the first pipes;
a process of next arranging a crane on one side of the right and left sides with respect to the first frame;
a process of next connecting the first pipe and the second pipe located at a rear of the first pipe by the crane; and
a process of connecting the first cable rack and the second cable rack located at a rear of the first cable rack.
